(19) United States
(12) Patent Application Publication
(10) Pub. No.: US 2014/0234504 A1
(43) Pub. Date: Aug. 21, 2014

(54) METHODS FOR EXTENDING THE SHELF LIFE OF WHOLE AND PROCESSED CAPSICUM ANNUUM FRUIT

(71) Applicant: Andy Hernandez, Kalispell, MT (US)

(72) Inventor: Andy Hernandez, Kalispell, MT (US)

(21) Appl. No.: 14/168,935

(22) Filed: Jan. 30, 2014

Related U.S. Application Data
(60) Provisional application No. 61/766,618, filed on Feb. 19, 2013.
(60) Provisional application No. 61/766,622, filed on Feb. 19, 2013.

(51) Int. Cl. A23B 7/157; A23L 1/212

(52) U.S. Cl. CPC A23B 7/157; A23L 1/2123
USPC 426/326

(57) ABSTRACT

Methods for extending the shelf life of whole and processed capsicum annuum fruit are provided herein. A method may include sanitizing a capsicum annuum fruit, drying the capsicum annuum fruit, removing a pepper stem, calyx, septum and capsaicin gland from the capsicum annuum fruit, sealing the capsicum annuum fruit in packaging, and cooling the capsicum annuum fruit to a temperature within a range of approximately 34° F. to approximately 40° F., inclusive.

### CROSS-REFERENCE TO RELATED APPLICATIONS

This non-provisional U.S. patent application claims the priority benefit of U.S. Provisional Application Ser. No. 61/766,618, filed on Feb. 19, 2013, titled “Process for Extending the Shelf Life of Whole Peppers”. This non-provisional U.S. patent application also claims the priority benefit of U.S. Provisional Application Ser. No. 61/766,622, filed on Feb. 19, 2013, titled “Process for Extending the Shelf Life of Sliced Peppers”, which are all hereby incorporated herein by reference in their entireties including all references cited therein.

### FIELD OF THE INVENTION

The present technology is directed generally to methods for improving the shelf-life of Capsicum Annuum fruit, such as bell peppers. The present technology extends the shelf life for both whole and sliced versions of the fruit.

### SUMMARY OF THE PRESENT TECHNOLOGY

According to some embodiments, the present technology may be directed to method for extending the shelf-life of a capsicum annuum fruit, the method comprising: (a) sanitizing a capsicum annuum fruit; (b) drying the capsicum annuum fruit; (c) removing a pepper stem, calyx, septum and capsaicin gland from the capsicum annuum fruit; (d) sealing the capsicum annuum fruit in packaging; and (e) cooling the capsicum annuum fruit to a temperature within a range of approximately 34° F. to approximately 40° F., inclusive.

According to some embodiments, the present technology may be directed to a method for processing a capsicum annuum fruit, the method comprising: (a) removing a pepper stem, calyx, septum and capsaicin gland from the capsicum annuum fruit; (b) slicing the capsicum annuum fruit; (c) sealing the capsicum annuum fruit in packaging; and (d) cooling the capsicum annuum fruit to a temperature within a range of approximately 34° F. to approximately 40° F., inclusive.

According to other embodiments, the present technology may be directed to a method for storing capsicum annuum fruit for up to 18 days, the method comprising: (a) harvesting the capsicum annuum fruit; (b) sanitizing an exocarp of the capsicum annuum fruit; (c) drying the capsicum annuum fruit; (d) removing a pepper stem, calyx, septum and capsaicin gland from the capsicum annuum fruit by hand or tool in such a way that damage to the exocarp, endocarp, pericarp, and crown are minimized, further wherein removing the pepper stem, calyx, septum and capsaicin gland from the capsicum annuum fruit does not damage a locule of the capsicum annuum fruit; (e) sealing the capsicum annuum fruit in packaging; and (f) cooling the capsicum annuum fruit to a temperature within a range of approximately 34° F. to approximately 40° F., inclusive.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a perspective view of a capsicum annuum fruit (bell pepper);

FIG. 2A is a top down view of a bell pepper that has been sliced in half;

FIG. 2B is a cross sectional view of a bell pepper that has been sliced lengthwise;

FIG. 3 illustrates Alternaria rot on a stem of a bell pepper;

FIG. 4 illustrates Alternaria rot on internal portions of the bell pepper;

FIG. 5 illustrates shriveling of a bell pepper;

FIG. 6 is a flowchart of a method for extending the shelf-life of a capsicum annuum fruit;

FIG. 7 is a perspective view of a sanitized bell pepper;

FIG. 8 is a perspective view if a processing implement for removing portions of a bell pepper;

FIG. 9 illustrates the placement of the processing implement;

FIG. 10 illustrates the placement of a bell pepper, stem down, on the processing implement;

FIG. 11 illustrates the removal of the stem, calyx, septum and capsaicin gland from the bell pepper; and

FIG. 12 is a flowchart of a method for storing capsicum annuum fruit for up to 18 days.

### DESCRIPTION OF EXEMPLARY EMBODIMENTS

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/or components, but do not preclude the presence or addition of one or more other features, integers, steps, operations, elements, components, and/or groups thereof.

The present technology comprises extending the shelf life of capsicum annuum fruit, hereinafter referred to as “fruit”, using a postharvest processing method. Methods included herein describe processes for extending the shelf life of both whole and sliced fruit. More specifically, the present technology includes methods and processes for maintaining bell pepper shelf life in a 34 to 40 degree F. environment, contrary to United States Department of Agriculture (USDA) guidelines.

For context, it will be understood that USDA guidelines published in the Blue Book Reference Guide, namely the seventh edition published by Produce Reporter Company 2008, sets forth various trading guidelines. These trading guidelines were established by Produce Reporter Co. in cooperation with the industry prior to the time that federal legislation in the United States and Canada was enacted. These guidelines provide a means to transact business with the necessary care and on a more assured basis with respect to certain produce items.

The Commodity Reference sets forth guidelines for bell peppers, namely green, red, yellow and orange peppers, which may be graded as U.S. Fancy No. 1 and U.S. No. 2. These peppers may be transported in containers in amounts of 25 to 30 lb. per bushel or carton, 1 1/9 bushel crate and 3.56 decaliter cartons.

The guidelines further set forth that ice contact with peppers is not recommended and that peppers are ethylene sensitive. Moreover, the USDA recommends that peppers be stored at temperatures ranging between 45 degrees to 55 degrees F. (7.2 to 12.8 C)

Mature green peppers held at temperature below 45 degrees may develop chilling injury. This injury manifests itself as pitting and scalds which creates the potential for invasion of decay organisms. At temperature above 55 degrees F. decay will develop rapidly.

The guidelines also specify acceptable defect levels for peppers. For example, For U.S. No. 1 grade, unless otherwise noted, allowable defects may include 10% totaling including 5% serious including 2% decay. The pepper size may also be limited. For example, for U.S. Fancy, the guidelines specify a three inch minimum diameter and three and one half inch minimum length. For U.S. No. 1, a two and a half inch minimum diameter and two and a half inch minimum length are required.

Most defects must be serious for a pepper to score in the U.S. No. 2 grade. 5% tolerances for sun scald in U.S. No. 2 10% tolerance for size. To be certified as red at least 90% of the pepper must show red color.

Various quality defects are also addressed in the guidelines such as maturity, shape, cleanness, scars, sunburn, and sun scald. Injuries from insects can also affect grading.

Condition defects may also be quantified and compared to the guidelines such as freshness, firmness, color, turning red or red, crushed or broken, bruising, shriveling, frozen, alternaria rot, bacterial soft rot, gray mold rot, rhizopus rot, phytophtora rot, and so forth.

It is also important to remember that in mature green peppers, any peppers showing red color are scored as damage against the grade. Peppers which show red color should be shipped as red, turning red or mixed color. Lots which are designated as red should have 90% or more of the peppers showing some red color.

The challenge of increasing population and shrinking farm acreage, food production and sustainability from farm to plate must be achieved through innovation and intellectual property.

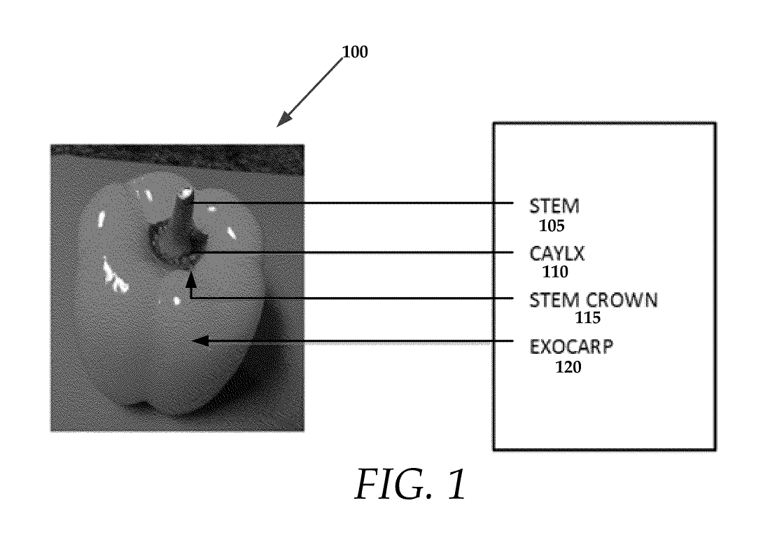

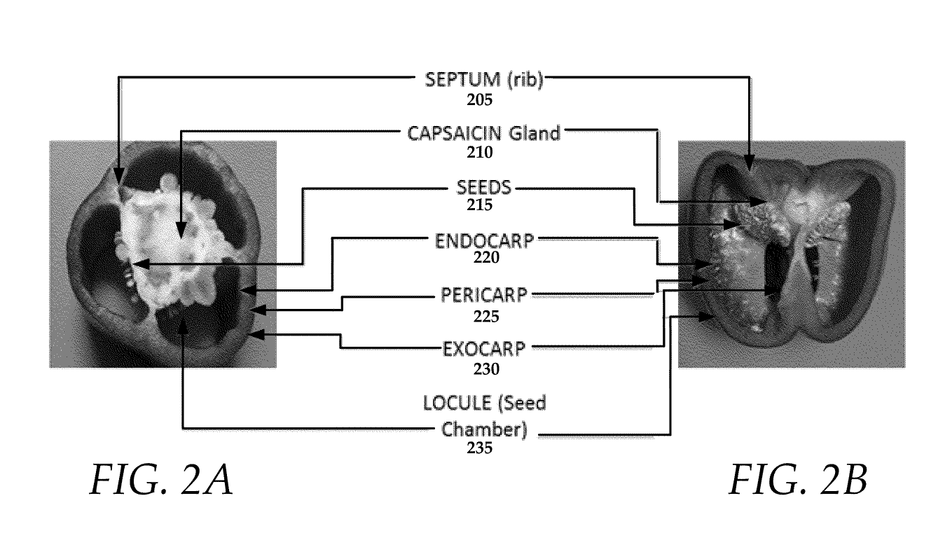

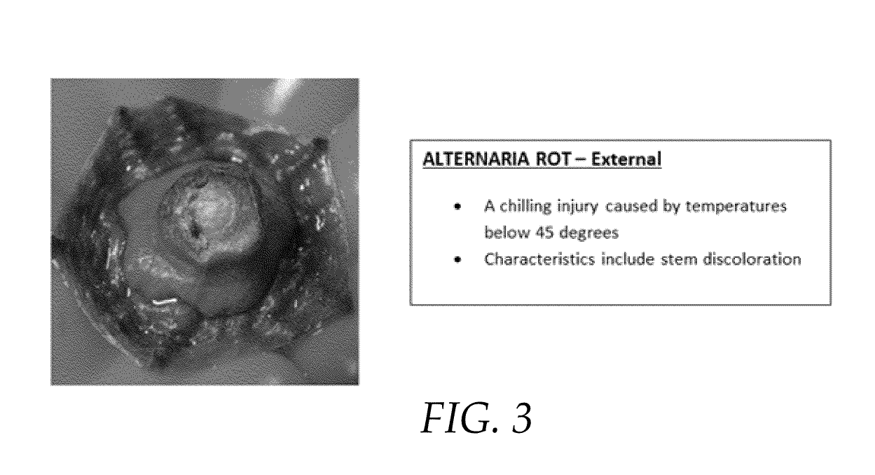

FIG. 1 is a perspective view of a bell pepper 100, illustrating a stem 105, a calyx 110, a stem crown 115, and an exocarp 120. The stem 105 attaches the bell pepper fruit to the remainder of the capsicum annuum plant. The calyx 110 is the cap that forms a connection between the stem 105 and the internal portions of the pepper, such as the locule (see FIGS. 2 and 3). The stem crown 115 extends around the calyx 110 and joins with the exocarp 120. The exocarp 120 is the outermost skin of the pepper and forms a protective barrier around the internal portions of the pepper, which are illustrated in FIGS. 2A and 2B.

FIG. 2A is a top down view of a bell pepper that has been sliced in half. The pepper includes a septum 205, capsaicin gland 210, seeds 215, endocarp 220, pericarp 225, exocarp 230, and locule 235, which forms a chamber for the seeds 215. FIG. 2B is a cross sectional view of a bell pepper that has been sliced lengthwise. The various parts of the bell pepper would be known to one of ordinary skill in the art. A description of their respective placements and functions will be omitted for purposes of brevity, except that, as mentioned throughout, the stem 105, calyx 110, septum 205 and capsaicin gland 210 are removed during processing to reduce or eliminate respiration and increase shelf life of the bell pepper. In some embodiments, keeping the endocarp 220, pericarp 225, exocarp 230, and locule 235 intact is preferred. In other embodiments, removing at least one or more of the above portions of the bell pepper is preferred.

Since bell peppers have always been sold in an un-cut form (e.g., not fresh pre-cut packaged produce), they are not included in the fastest growing category of “value added” in the foodservice and retail sector, which is fresh pre-cut packaged produce. Consumers will benefit with extended shelf life, reduced food safety concerns, and improved quality provided by the present technology.

The United States Department of Agriculture (USDA) guidelines clearly state that the optimum storage temperature for bell pepper is 45 to 55 degrees for optimum shelf life. These temperature requirements have been the greatest obstacle to pre-cut innovation. This new process method will allow bell pepper to enter the standard 34 to 40 degree environment. The process will mitigate spoilage, extend shelf-life, reduce waste and economic loss at the retail, food-service (restaurant), and consumer levels. It will also stimulate economic growth at the farm level as additional marketing opportunities will open in the “value added” category of fresh pre-cut packaged produce.

Bell peppers are grown in the field and are harvested in bulk bins. Each bin holds 300 pounds of produce. Once the bins are filled, they are sent to a sorting and packing facility and transferred to conveyors. The peppers travel at a high rate of speed on these conveyors sorted by human eyes and hands according to size, color, and defects. Once sorted, they continue traveling on the conveyors and are dropped into cartons based on size. These cartons weigh approximately 25 pounds. This packing process has drawbacks; stem puncture, bruising, and cracks occurs on some of the peppers. The product is then shipped to market on 52 foot refrigerated trailers at 45 to 55 degrees F.

Retail and restaurant produce managers will discard approximately 12% per carton upon arrival. This number can rise to as high as 35% if inventory sits for three to five days due to deterioration from the initial packing process. The discarded peppers may have stem punctures, bruising, cracks and an additional defect, decay. This discard is known as “shrink.”

Aging and deterioration are a continuous process. However, the rate of aging depends upon the item itself and the conditions under which it is held. Most fresh vegetables are near or at their prime when harvested. Transportation is a time consuming process, which affects the quality of the vegetables. Further, most vegetables are displayed in the market at ambient temperature under water spraying jets. These displays are a haven for bacteria growth; the produce is freely handled by shoppers and sometimes dropped on the floor.

The following paragraphs describe common disorders that affect bell peppers. The bell pepper (capsicum annuum) may suffer from a number of physiological and pathological disorders as well as postharvest defects. These shortcomings create significant economic loss at all consumer levels. Physiological may be found in the field during the growth cycle of the bell pepper. They are easily identified prior to harvest and are culled. For example, blossom end rot occurs as a slight discoloration or a severe dark sunken lesion at the blossom end. Blossom end rot is caused by temporary insufficiencies of water and calcium and may occur under high temperature conditions when the peppers are rapidly growing.

In another example, pepper speck appears as spot-like lesions that penetrate the fruit wall. While the cause is unknown, it is appreciated that some varieties of bell pepper are more susceptible than others.

Pathological disorders may also be present. These disorders occur in the field during the growth cycle of the bell pepper. They are not easily identified prior to harvest and can bypass the packing phase quality control practices and enter the distribution channels. For example, botrytis or grey mold decay is a common decay causing organism on peppers. Field sanitation and prevention of wounds on the fruit during packaging help reduce incidence of this pathology. It is noteworthy to mention that botrytis will thrive at the recommended storage temperatures set forth by the USDA.

In another example, bacterial soft rot can be caused by several bacteria which attack damaged exocarp (outer skin or covering) tissue. Soft rot damage can be common on washed or hydro-cooled peppers where water sanitation was deficient.

Bell peppers may also be subject to postharvest defects, which are common and occur at harvest, packaging, shipping and final distribution operations. These injuries commonly occur inside the carton and usually discovered when the packaging is opened.

Mechanical damage to the bell peppers may also occur. Indeed, the exocarp of the bell pepper is fragile and easily bruised. The majority of the bruising occurs during harvest and packing when peppers fall from conveyors onto uncushioned conveyors and rollers. Bruising effects from harvesting include stem punctures and cracks. Physical injury not only detracts from the visual quality of the peppers but also causes increased water loss, bacteria entry, and decay.

Bell peppers may also be subject to chilling injuries, which are the single most common disorder. Chilling injuries include surface pitting, water-soaked areas, decay (Alternaria rot on the stem), and discoloration of the seed cavity. When exposed to chilling temperatures, the stem of the bell pepper becomes a conduit for Alternaria rot. This defect affects the interior and presents itself as grey mold and discolored seeds.

Shriveling of bell peppers may occur when the bell pepper is stored at temperatures below 45 degrees F. and above 45 degrees F. Shriveling presents when water loss occurs. The exocarp of the bell pepper may shrivel or show signs of dehydration. The exocarp and endocarp (interior membrane) of a bell pepper are non-porous and the loss of moisture occurs as the septum pulls moisture from the pericarp to maintain the capsaicin gland (seeds) while moisture evaporates through the stem. FIG. 5 illustrates shriveling of a bell pepper where the exocarp of the bell pepper shows wrinkling.

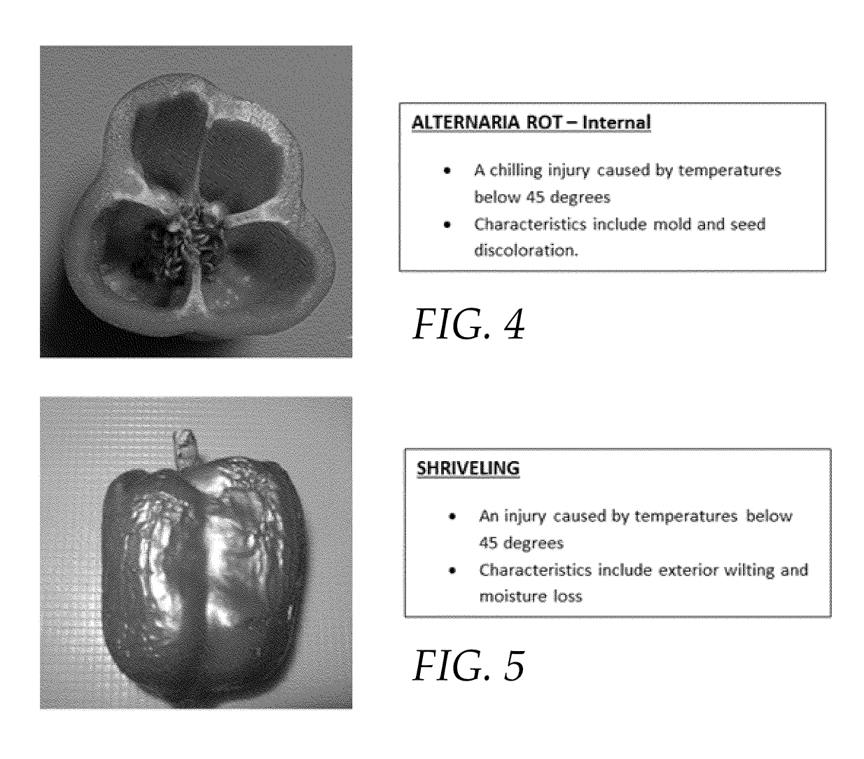

The presence of black Alternaria rot on the stem end of the bell pepper is a symptom of chilling injury during postharvest handling. The defects include the discoloration of seeds, and expose the inner cavity to bacteria which produces mold and reduces shelf life. FIG. 3 illustrates Alternaria rot on a stem of a bell pepper. FIG. 4 illustrates Alternaria rot on internal portions of the bell pepper, such as the seeds.

In accordance with guidelines established by the USDA, mature green, red, yellow and orange peppers held at temperature below 45 degrees F. may develop chilling injury. This injury manifests itself as pitting and scalds which open the door to the invasion of decay organisms. At temperature above 55 degrees F. decays will develop rapidly.

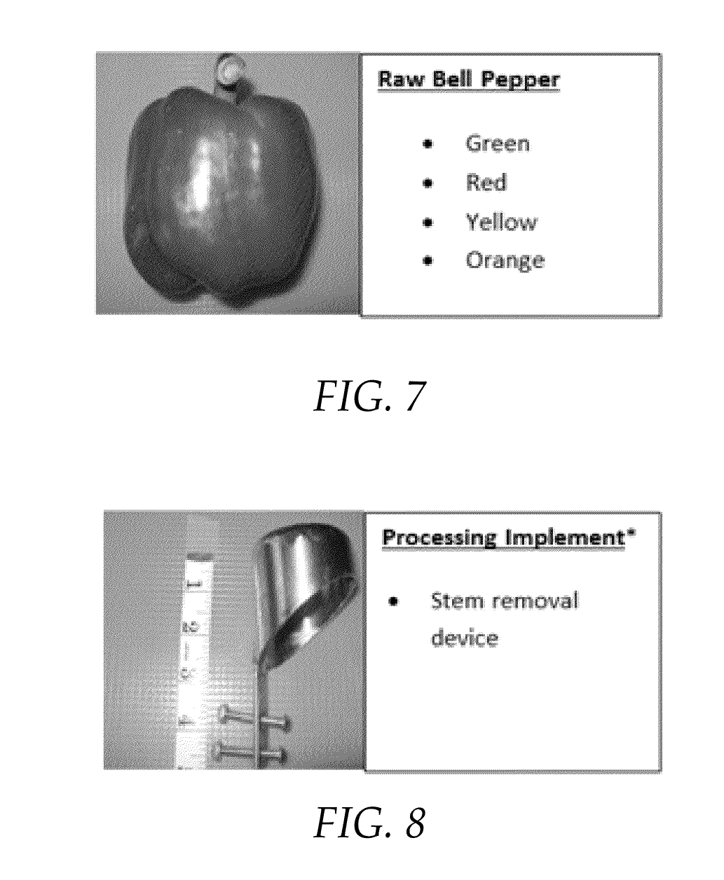

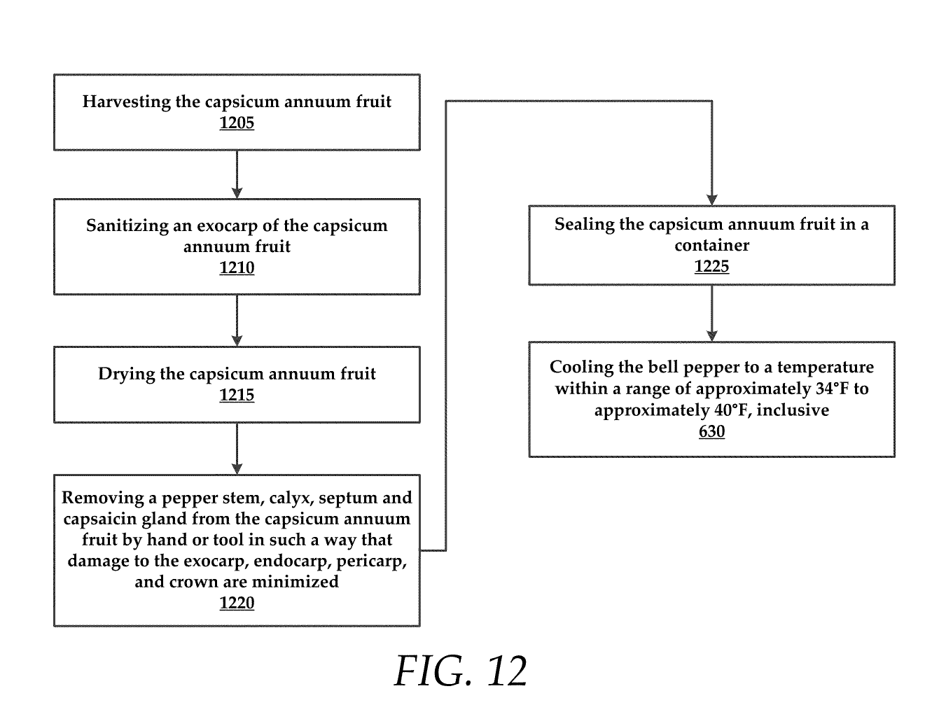

To extend shelf life of fresh produce at the commercial or home level these living vegetables must be put to “sleep”. Indeed, the methods described herein provide processes whereby a capsicum annuum fruit may be sanitized and dried. Portions of the bell peppers that are subject to damage or may promote any of the disorders described above are removed. Next, the bell peppers are packaged and chilled. Bell peppers processed in the aforementioned manner may have a shelf life of at least 18 days. In some embodiments, the bell peppers may be sliced or otherwise fragmented the bell peppers prior to packaging. More specifics regarding these processes are provided below with reference to FIGS. 7 and 12.

In general, the post-harvest metabolism of fruits and vegetables functions very much like that of a human being while sleeping. While sleeping, humans burn fewer calories and lose less water than when we are awake doing any activity. Once cut from the mother plant, the stem, calyx, tissue and capsaicin gland will no longer have access to nutrients from the plant. Additionally, if the fruit or vegetable is damaged during the harvest and packing process metabolism of the fruit increases significantly. The fruit or vegetable is now vulnerable and is fighting for survival in the new environment. The energy to keep them alive can only be taken from their own tissue (e.g., from what has been stored up to that moment of harvest). This process is called respiration.

Respiration provides energy for the fruit by consuming oxygen in combination with carbohydrates. The fruit releases carbon dioxide as a byproduct of respiration. To assist in controlling respiration, Modified Atmosphere Packaging (MAP) reduces the concentration of oxygen in the atmosphere and increases carbon dioxide which suppresses respiration.

The processes of the present technology may mitigate, reduce or eliminate tissue damage along with chilling injury, shriveling, and Alternaria rot.

The exocarp (outer skin) of the bell pepper is non-porous. Typically, no moisture is lost once removed from the mother plant unless mechanical damage to the exocarp occurs during the harvesting or packing process. These injuries allow moisture loss and pathogens can enter the damaged area. The stem, calyx and septum respire at a very high rate and their sole responsibility is to protect the capsaicin gland (seed packet) for reproduction.

Thus, removing the stem, calyx, septum, and capsaicin gland and incorporating MAP, the grower can now place the bell pepper in the new temperature of 34 to 40 degrees F., which will slow down the aging process (e.g., respiration) and force the bell pepper to “sleep”. Shelf life may be extended up to 18 days.

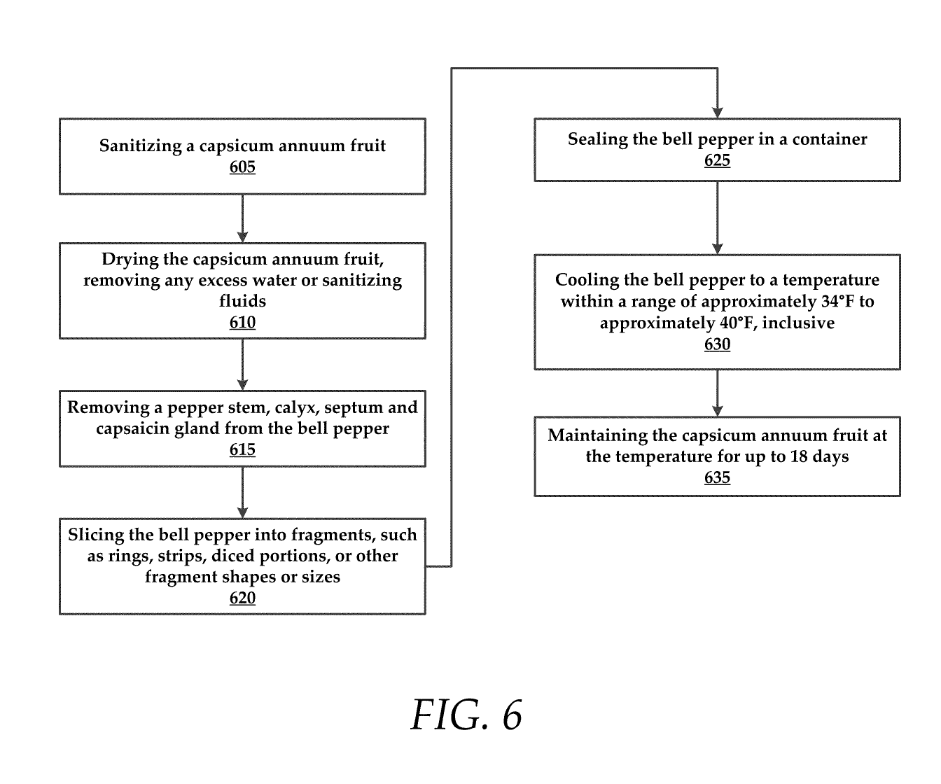

FIG. 6 is a flowchart of a method for extending the shelf-life of a capsicum annuum fruit (bell pepper). According to some embodiments, the method may include sanitizing 605 a capsicum annuum fruit. Sanitizing may include washing the bell pepper one or more times to remove dirt and other contaminates. In some instances, a fluid such as water that is mixed with a sanitizer, such as chlorine may be used. For example, water having chlorine at 100 ppm may be utilized.

It will be understood that prior to sanitizing, the bell peppers may be harvested by manual or mechanical means. Further, the harvesting process may include gently placing the bell peppers in a plastic container, paying attention not to damage the bell peppers, such as piercing or bruising the exocarp of the bell peppers. FIG. 7 illustrates a sanitized bell pepper.

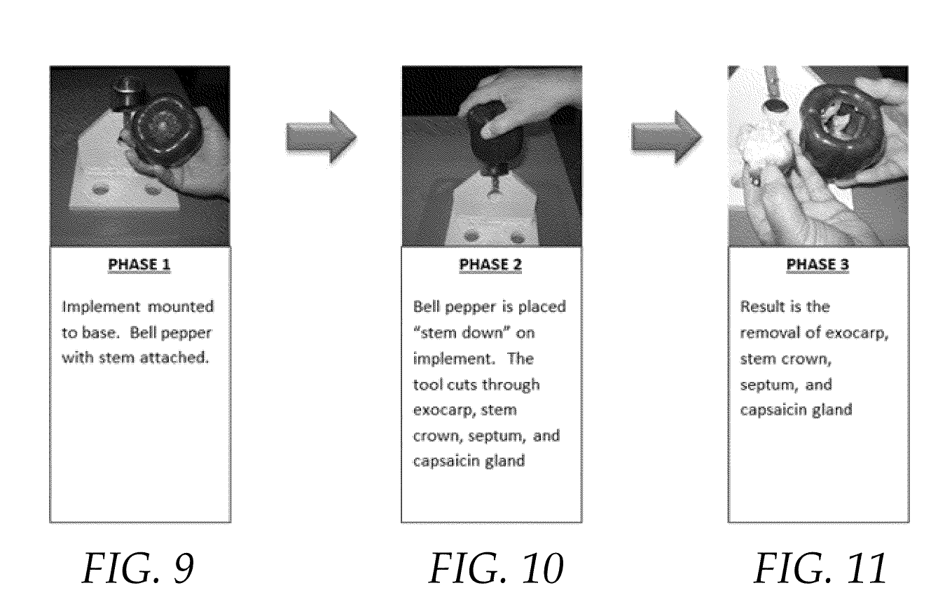

Next, the method includes drying 610 the capsicum annuum fruit, removing any excess water or sanitizing fluids. The method also includes removing 615 a pepper stem, calyx, septum and capsaicin gland from the bell pepper. FIG. 8 illustrates an example of a processing implement that can be used to remove the stem, calyx, septum and capsaicin gland from a bell pepper. FIGS. 9-11 illustrate an exemplary process for removing the stem, calyx, septum and capsaicin gland from the bell pepper. In phase 1 of FIG. 9, the cutting implement is positioned. In phase 2 of FIG. 10, the bell pepper is placed stem down onto the implement. The tool cuts the stem, calyx, septum and capsaicin gland from the bell pepper. Phase 3 of FIG. 11 illustrates the removal of the stem, calyx, septum and capsaicin gland from a bell pepper. Further, it will be appreciated that the exocarp and other portions of the bell pepper remain intact.

In some embodiments, the method may optionally include slicing 620 the bell pepper into fragments, such as rings, strips, diced portions, or other fragment shapes or sizes.

The method may include sealing 625 the bell pepper (either whole or in fragments) in packaging (such as MAP packaging) and cooling 630 the bell pepper to a temperature within a range of approximately 34° F. to approximately 40° F., inclusive. In some instances, sealing may include hermetically sealing the bell pepper in the packaging.

According to some embodiments, the method may include maintaining 635 the capsicum annuum fruit at the temperature for up to 18 days. During this 18 day period, the bell pepper may be transported or displayed, so long as the temperature of the bell pepper remains at a temperature that is within a range of approximately 34° F. to approximately 40° F., inclusive.

FIG. 12 is a flowchart of an exemplary method for storing capsicum annuum fruit for up to 18 days. The method may include harvesting 1205 the capsicum annuum fruit, and sanitizing 1210 an exocarp of the capsicum annuum fruit. The method includes drying 1215 the capsicum annuum fruit.

Using a tool or instrument, the method includes removing 1220 a pepper stem, calyx, septum and capsaicin gland from the capsicum annuum fruit by hand or tool in such a way that damage to the exocarp, endocarp, pericarp, and crown are minimized, further wherein removing the pepper stem, calyx, septum and capsaicin gland from the capsicum annuum fruit does not damage a locule of the capsicum annuum fruit.

In some instances, the method includes sealing 1225 the capsicum annuum fruit in packaging, and cooling 1230 the capsicum annuum fruit to a temperature within a range of approximately 34° F. to approximately 40° F., inclusive.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for extending the shelf-life of a capsicum annuum fruit, the method comprising:
sanitizing a capsicum annuum fruit;
drying the capsicum annuum fruit;
removing a pepper stem, calyx, septum and capsaicin gland from the capsicum annuum fruit;
sealing the capsicum annuum fruit in packaging; and
cooling the capsicum annuum fruit to a temperature within a range of approximately 34° F. to approximately 40° F., inclusive.

2. The method according to claim 1, wherein sanitizing comprises washing the whole capsicum annuum fruit in a fluid that comprises water with 100 ppm chlorine.

3. The method according to claim 1, further comprising harvesting the whole capsicum annuum fruit; and placing the harvested whole capsicum annuum fruit in a tray in such a way that bruising and stem punctures of an exocarp of the whole capsicum annuum fruit is minimized.

4. The method according to claim 1, wherein sealing comprises hermetically sealing the whole capsicum annuum fruit in the packaging.

5. The method according to claim 1, further comprising maintaining the capsicum annuum fruit at the temperature for up to 18 days.

6. The method according to claim 1, further comprising shipping the capsicum annuum fruit to market at a temperature within a range of approximately 34° F. to approximately 40° F., inclusive.

7. The method according to claim 1, further comprising slicing the capsicum annuum fruit into fragments prior to sealing.

8. A method for processing a capsicum annuum fruit, the method comprising:
removing a pepper stem, calyx, septum and capsaicin gland from the capsicum annuum fruit;
slicing the capsicum annuum fruit;
sealing the capsicum annuum fruit in packaging; and
cooling the capsicum annuum fruit to a temperature within a range of approximately 34° F. to approximately 40° F., inclusive.

9. The method according to claim 8, prior to slicing the capsicum annuum fruit:
sanitizing a capsicum annuum fruit; and
drying the capsicum annuum fruit.

10. The method according to claim 8, wherein sanitizing comprises washing the whole capsicum annuum fruit in a fluid that comprises water with 100 ppm chlorine.

11. The method according to claim 10, wherein sealing comprises hermetically sealing the whole capsicum annuum fruit in the packaging.

12. The method according to claim 11, further comprising shipping the capsicum annuum fruit to market at a temperature within a range of approximately 34° F. to approximately 40° F., inclusive.

13. The method according to claim 12, further comprising maintaining the capsicum annuum fruit at the temperature for up to 18 days.

14. The method according to claim 13, further comprising harvesting the whole capsicum annuum fruit; and placing the harvested whole capsicum annuum fruit in a tray in such a way that bruising and stem punctures of an exocarp of the whole capsicum annuum fruit is minimized.

15. A method for storing capsicum annuum fruit for up to 18 days, the method comprising:
harvesting the capsicum annuum fruit;
sanitizing an exocarp of the capsicum annuum fruit;
drying the capsicum annuum fruit;
removing a pepper stem, calyx, septum and capsaicin gland from the capsicum annuum fruit by hand or tool in such a way that damage to the exocarp, endocarp, pericarp, and crown are minimized, further wherein removing the pepper stem, calyx, septum and capsaicin gland from the capsicum annuum fruit does not damage a locule of the capsicum annuum fruit;
sealing the capsicum annuum fruit in packaging; and
cooling the capsicum annuum fruit to a temperature within a range of approximately 34° F. to approximately 40° F., inclusive.
